(19) United States
(12) Patent Application Publication
(10) Pub. No.: US 2026/0070559 A1
(43) Pub. Date: Mar. 12, 2026

(54) VEHICLE CONTROL METHOD AND A VEHICLE IMPLEMENTING THE SAME

(71) Applicants: HYUNDAI MOTOR COMPANY, Seoul (KR); KIA CORPORATION, Seoul (KR)

(72) Inventors: Je Kyung Lee, Hwaseong-si (KR); Ho Young kim, Hwaseong-si (KR)

(73) Assignees: HYUNDAI MOTOR COMPANY, Seoul (KR); KIA CORPORATION, Seoul (KR)

(21) Appl. No.: 19/264,605

(22) Filed: Jul. 9, 2025

(30) Foreign Application Priority Data
Sep. 12, 2024 (KR) 10-2024-0124743

(51) Int. Cl. B60W 30/19; B60W 10/06; B60W 10/10; B60W 30/16

(52) U.S. Cl. CPC B60W 30/19; B60W 10/06; B60W 10/10; B60W 30/16

(57) ABSTRACT

A vehicle includes a driving unit; a continuously variable transmission that changes a rotary output of the driving unit; and a controller that controls the driving unit and the continuously variable transmission. In particular, the controller controls the driving unit to implement a set automatic drive control, and performs control of a virtual shift stage through control of the continuously variable transmission according to a state of the driving unit during the automatic drive control.

### CROSS-REFERENCE TO RELATED APPLICATION

This application claims priority to Korean Patent Application No. 10-2024-0124743, filed on Sep. 12, 2024, the entire contents of which are incorporated herein by reference.

### TECHNICAL FIELD

The present disclosure relates to a method of controlling a vehicle and a vehicle implementing the control method.

### BACKGROUND

A technology of an advanced drive assistance system is being commercialized, and thus the number of vehicles equipped with automatic drive control functions that operate under a specific conditions is significantly increasing.

For example, under a cruise control function, a controller automatically controls a vehicle in accordance with a set control logic without a driver's operation of an accelerator pedal or a brake pedal.

Early-stage cruise control technology allowed a vehicle to maintain a constant speed under a preset condition, but it has since evolved into what is known as smart cruise control (SCC).

The smart cruise control is, for example, a function that enables a vehicle to follow the speed of a target vehicle or to automatically accelerate or decelerate based on a distance to a preceding vehicle.

Depending on the applied SCC, the SCC may include a ‘Stop & Go’ function that monitors from the distance to a preceding vehicle and, when the preceding vehicle stops, brings the vehicle to a stop and then resumes movement once the preceding vehicle starts moving again.

In a case of an internal combustion engine vehicle, in particular, in a case of a vehicle equipped with a continuously variable transmission (CVT), an undesirable change in engine RPM may occur during travel under the smart cruise control (SCC).

This is because a change in engine RPM is directly related to a demand torque due to the nature of the CVT control.

For example, when no preceding vehicle is present and a target vehicle speed follow-up control is being favorably implemented, a slight change in road gradient—such as during mild uphill or downhill driving—may result in engine RPM variation (e.g., engine RPM fluctuation) without a substantial change in vehicle speed, due to a change in the demand torque required to maintain a target vehicle speed.

In addition, in a state where a target vehicle speed follow-up control is being favorably implemented, and a preceding vehicle is traveling at a distance equal to or greater than a standard distance defined by a vehicle-to-vehicle distance follow-up control, a variation in a sensing distance from the preceding vehicle may occur due to temporary performance degradation of a sensor for the SCC, for example, a front camera or a radar. In this case, engine RPM variation may occur.

In addition, in a state where there is no preceding vehicle and a target vehicle speed follow-up control is being favorably implemented, there may occur a situation of engine RPM variation due to control characteristics of an engine or brake. For example, in a case where brake follow-up is delayed due to a limitation of a hardware, control of actual torque is delayed compared to the target, and thus there may occur oscillation of torque control, and there may occur a situation in which variation in the demand torque frequently occurs during traveling at a target vehicle speed constantly, and thus engine fuel cut control is repeated.

The statements in this section merely provide background information related to the present disclosure and may not constitute prior art.

### SUMMARY

An object of at least one embodiment of the present disclosure is to resolve at least one of technical tasks that have been described above.

At least one embodiment of the present disclosure is to prevent excessive RPM variation phenomenon of a driving unit during automatic drive control.

According to an embodiment of the present disclosure, a vehicle includes: a driving unit, a continuously variable transmission configured to change a rotational output speed of the driving unit, and a controller configured to control the driving unit and the continuously variable transmission. In particular, the controller is further configured to: control the driving unit according to a set automatic drive control, and control the continuously variable transmission according to a virtual gear-shift control based on a state of the driving unit during the automatic drive control.

In at least one embodiment of the present disclosure, the state of the driving unit includes a revolution per minute (RPM) state of the driving unit.

In at least one embodiment of the present disclosure, the RPM state includes a state in which an RPM variation greater than or equal to a preset value occurs at least a preset number of times.

In at least one embodiment of the present disclosure, the controller is further configured to determine that a vehicle traveling in front of the vehicle (i.e., a preceding vehicle) exists within a preset distance, and start the virtual gear-shift control.

In at least one embodiment of the present disclosure, the controller is further configured to start the virtual gear-shift control based on a follow-up state indicative of a degree of correspondence between a current vehicle speed and a target vehicle speed of the vehicle.

In at least one embodiment of the present disclosure, the controller is configured to: divide a transmission ratio of the continuously variable transmission into a plurality of virtual gears, and control the continuously variable transmission according to the plurality of virtual gears.

In at least one embodiment of the present disclosure, when controlling the continuously variable transmission according to the plurality of virtual gears, the controller is configured to select a virtual gear among the plurality of virtual gears based on the current vehicle speed and the RPM of the driving unit.

When controlling the continuously variable transmission based on the plurality of virtual gears, the controller is configured to determine a virtual accelerator pedal sensor (APS) value based on a target torque, and perform a gear shift from a first virtual gear to a second virtual gear, among the plurality of virtual gears, based on the virtual APS value.

In at least one embodiment of the present disclosure, the gear shift among the plurality of virtual gears includes up-shifting or down-shifting according to the virtual APS value, the current vehicle speed, and a preset shift pattern.

In at least one embodiment of the present disclosure, the step of shifting among the plurality of virtual gears further includes a step of implementing up-shifting or down-shifting according to the virtual APS value, the vehicle speed, and a set shift pattern.

In at least one embodiment of the present disclosure, the automatic drive control includes a cruise control.

According to an embodiment of the present disclosure, there is provided a method of controlling a vehicle. The vehicle includes a driving unit, a continuously variable transmission configured to change a rotational output speed of the driving unit, and a controller configured to control the driving unit and the continuously variable transmission. In an embodiment, the method comprises: controlling, by the controller, the driving unit according to a set automatic drive control, and controlling the continuously variable transmission according to a virtual gear-shift control based on a state of the driving unit during the automatic drive control.

In at least one embodiment of the present disclosure, the state of the driving unit includes a revolution per minute (RPM) state of the driving unit.

In at least one embodiment of the present disclosure, the RPM state includes a state in which an RPM variation greater than or equal to a preset value occurs at least preset number of times.

In at least one embodiment of the present disclosure, controlling the continuously variable transmission according to the virtual gear-shift control includes determining that a preceding vehicle is present within a preset distance, and starting the virtual gear-shift control.

In at least one embodiment of the present disclosure, controlling the continuously variable transmission according to the virtual gear-shift control includes starting the virtual gear-shift control according to a follow-up state indicative of a degree of correspondence between a current vehicle speed and a target vehicle speed of the vehicle.

In at least one embodiment of the present disclosure, the virtual gear-shift control includes dividing a transmission ratio of the continuously variable transmission into a plurality of virtual gears, and controlling the continuously variable transmission according to the plurality of virtual gears.

In at least one embodiment of the present disclosure, controlling according to the plurality of virtual gears includes controlling the continuously variable transmission according to a virtual gear selected among the plurality of virtual gears based on the vehicle speed and the RPM of the driving unit.

In at least one embodiment of the present disclosure, controlling according to the plurality of virtual gears further includes determining a virtual accelerator pedal sensor (APS) value based on a target torque, and shifting from a first virtual gear to a second virtual gear, among the plurality of virtual gears, according to the virtual APS value.

In at least one embodiment of the present disclosure, shifting from the first virtual gear to the second virtual gear, among the plurality of virtual gears, includes up-shifting or down-shifting according to the virtual APS value, the current vehicle speed, and a preset shift pattern.

In at least one embodiment of the present disclosure, the automatic drive control includes a cruise control.

According to at least one embodiment of the present disclosure, it is possible to prevent an excessive RPM variation phenomenon of a driving unit during automatic drive control.

In addition, according to at least one embodiment of the present disclosure, it is possible to reduce discomfort or anxiety that a driver feels due to RPM variation during SCC traveling.

### BRIEF DESCRIPTION OF THE DRAWINGS

FIG. 1 is a schematic diagram illustrating main components of a vehicle according to an embodiment of the present disclosure.

FIG. 2 is a flowchart illustrating a drive control process according to an embodiment of the present disclosure.

FIG. 3 illustrates an embodiment among shift patterns for a continuously variable transmission (CVT).

FIG. 4 illustrates a plurality of virtual gears for the CVT according to an embodiment of the present disclosure.

FIG. 5 illustrates a shift pattern for the CVT according to an embodiment of the present disclosure.

FIGS. 6A and 6B conceptually illustrate control results according to an embodiment of the present disclosure.

The drawings described herein are for illustration purposes only and are not intended to limit the scope of the present disclosure in any way.

### DETAILED DESCRIPTION

Because the present disclosure may be modified in various ways and may have various embodiments of the present disclosure, specific embodiments are illustrated and described in the drawings. However, this is not intended to limit the present disclosure to specific embodiments, and it should be understood that the present disclosure includes all modifications, equivalents, and replacements included on the idea and technical scope of the present disclosure.

The suffixes “module” and “unit” used herein are used only for name distinction between elements and should not be construed as being physiochemically divided or separated or assumed that they may be divided or separated.

Terms including ordinals such as “first”, “second”, and the like may be used to describe various elements, but the elements are not limited by the terms. The terms are used only as name meaning for distinguishing one element from another element, and sequential meaning between the elements are understood not from the name but from the context of the description.

The term “and/or” is used to include any combination of a plurality of items to be included. For example, “A and/or B” includes all three cases such as “A”, “B”, and “A and B”. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

When it is mentioned that an element is “connected” or “linked” to another element, it should be understood that the element may be directly connected or linked to another element, but another element may exist in between. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The terminology used herein is for describing specific exemplary examples only and is not intended to be limiting of the present disclosure. Singular expressions include plural expressions, unless the context clearly indicates otherwise. In the present application, it should be understood that the term “include” or “have” indicates that a feature, a number, a step, an operation, a component, a part, or a combination thereof described in the specification exists, but does not exclude the possibility of existence or addition of one or more other features, numbers, steps, operations, components, parts, or combinations thereof in advance.

Unless otherwise defined, all terms used herein, including technical or scientific terms, include the same meaning as that generally understood by those having ordinary skill in the art. It will be understood that terms, such as those defined in commonly used dictionaries, should be interpreted as including a meaning which is consistent with their meaning in the context of the relevant art and will not be interpreted in an idealized or overly formal sense unless so defined herein.

Furthermore, the term “unit”, “control unit”, “control device”, or “controller” is a term widely used for naming a controller that commands a specific function, and does not mean a generic function unit. For example, a control unit by these names may include a communication device that communicates with another controller or sensor to control a corresponding function, a computer-readable recording medium that stores an operating system or a logic command, input/output information, and the like, and one or more processors that perform judgement, calculation, determination, and the like necessary for controlling the corresponding function.

The processor may include a semiconductor integrated circuit and/or electronic systems that perform at least one or more of comparison, judgement, calculation, and determination to achieve a programmed function. For example, the processor may be one of a computer, a microprocessor, a CPU, an ASIC, and an electronic circuit (circuitry, logic circuits), or a combination thereof.

Furthermore, the computer-readable recording medium (or simply referred to as a memory) includes all types of storage devices in which data which may be read by a computer system is stored. For example, the memory may include at least one type of a flash memory, of a hard disk, of a micro, of a card (for example, a secure digital (SD) card or an Extream digital (XD) card), and the like, and at least one type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

The recording medium may be electrically connected to the processor, and the processor may retrieve and record data from the recording medium. The recording medium and the processor may be integrated or may be physically separated.

Hereinafter, each configuration of embodiments is described below in detail with reference to the accompanying drawings.

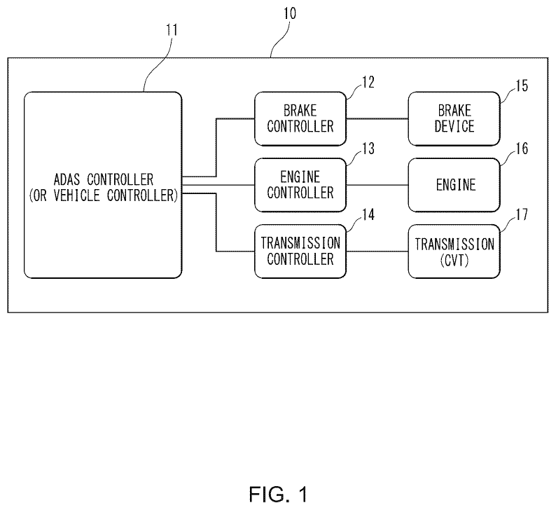

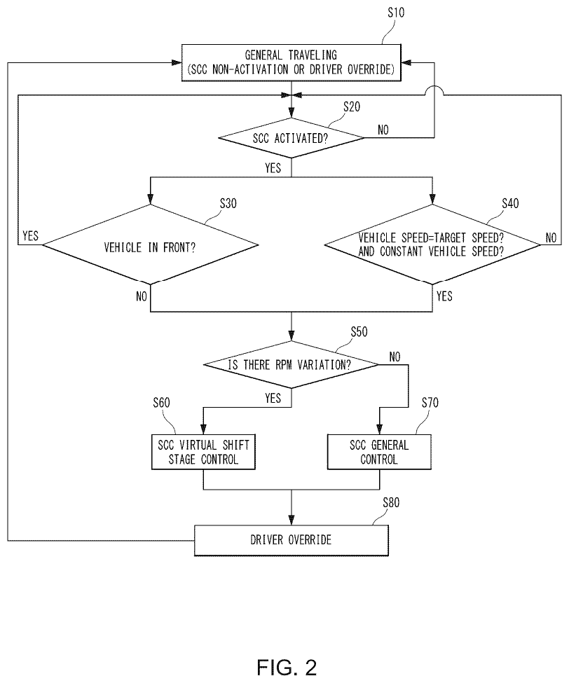

FIG. 1 is a schematic diagram conceptually illustrating a main configuration of a vehicle according to an embodiment of the present disclosure, and FIG. 2 is a flowchart illustrating a drive control process according to an embodiment of the present disclosure.

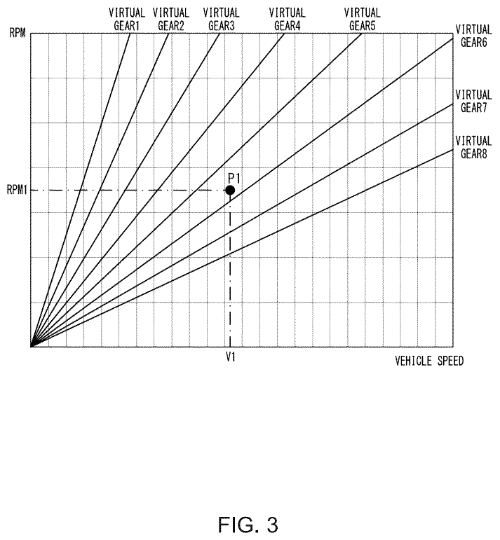

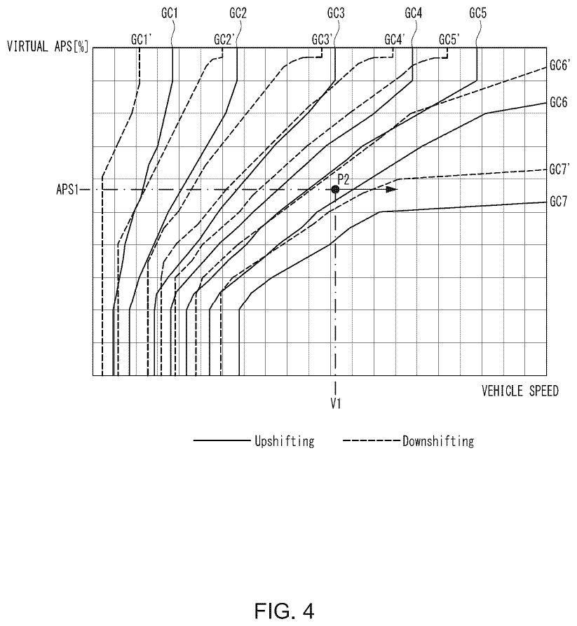

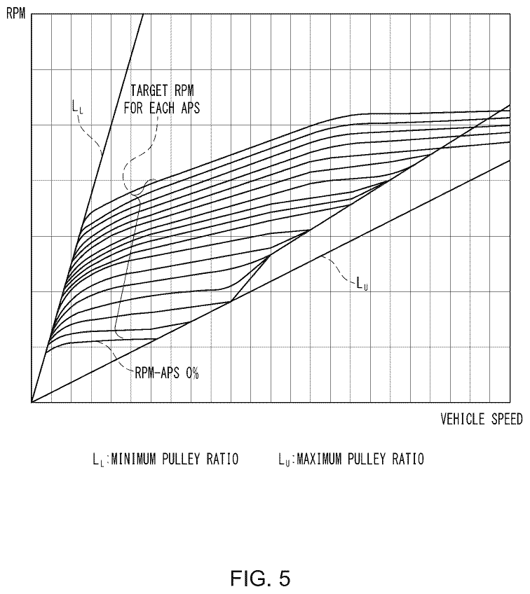

FIG. 3 illustrates an embodiment for shift patterns of a CVT, and FIGS. 4 and 5 exemplify a plurality of virtual gears and the shift patterns for the CVT according to an embodiment of the present disclosure.

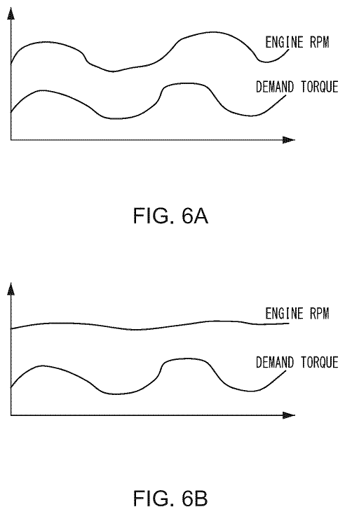

FIGS. 6A and 6b illustrate control results according to an embodiment of the present disclosure.

According to an embodiment of the present disclosure, with reference to FIG. 1, a vehicle (10) includes an advanced Driver Assistance System (ADAS) controller (11), a brake controller (12), a driving unit controller, and a transmission controller (14).

Here, the driving unit may include an engine (16), and in this case, the driving unit controller can be referred to as an engine controller (13).

The ADAS controller (11) can be provided separately from a vehicle controller, which is a top-level controller configured to control the entire vehicle (10), but is not limited thereto. In other words, the ADAS controller (11) may be integrated with the vehicle controller.

The ADAS controller (11) may include at least one automatic drive control function, and in the present embodiment, the SCC is included as an example of the automatic drive control function.

In addition, the ADAS controller (11) may further include at least one function of forward collision-avoidance assist (FCA), lane keeping assist (LKA), blind-spot collision-avoidance assist (BCA), safety exit assist (SEA), intelligent speed limit assist (ISLA), driver attention warning (DAW), blind-spot view monitor (BVM), lane following assist (LFA), highway driving assist (HDA), surround view monitor (SVM), rear cross-traffic collision-avoidance assist (RCCA), parking collision-avoidance assist (PCA), or remote smart parking assist (RSPA).

The ADAS controller (11) receives a sensing signal from various sensors, for example, a front camera, a rear camera, a front lateral camera, a rear lateral camera, a radar sensor, or a lidar sensor, and the ADAS controller (11) can control the brake controller (12), the engine controller (13), and the transmission controller (14) according to the received signal(s).

The brake controller (12) controls a brake device (15) according to an operation signal of a brake pedal, and can control the brake device (15) according to a command from the ADAS controller (11). For example, the brake controller (12) can receive a deceleration command from the ADAS controller (11) by determining that deceleration is required during SCC traveling, and thereby controls the brake device (15) to achieve deceleration of the vehicle (10).

The engine controller (13) controls an engine (16). For example, the engine controller (13) can control a fuel injector that provides the engine (16) with a fuel according to an accelerator pedal sensor (APS) signal by a driver's operation of an accelerator pedal. In addition, the engine controller (13) can control the engine (16) according to a command from the ADAS controller (11) as well. For example, in a case where acceleration is required for traveling at a target vehicle speed and thus the ADAS controller (11) transmits a command for acceleration to the engine controller (13). The engine controller (13) then controls the engine (16) to accelerate in accordance with the command.

The transmission controller (14) controls a continuously variable transmission (17) disposed between the engine (16) and a wheel of the vehicle.

The continuously variable transmission (17) is a type of transmission in which a transmission ratio varies continuously, unlike a conventional automatic transmission that is equipped with a plurality of discrete shift gears and performs gear changes according to a set gear ratio.

The continuously variable transmission (17) may be a belt drive type, for example, but is not necessarily limited thereto. A belt drive type transmission transmits power by connecting a pair of pulleys by a belt, and a transmission ratio varies by a pulley ratio. In the present embodiment, the transmission (17) is described as a belt drive type transmission for convenience.

In the present embodiment, the transmission controller (14) receives a command from the ADAS controller (11) and can control the transmission (17) according to this.

FIG. 2 exemplifies a vehicle drive control process according to an embodiment of the present disclosure, and this is described below.

Step S10 represents a state in which the vehicle (10) is traveling in a state where the SCC is in a non-active state or in a driver's override state which is a control state due to the driver's drive intervention even in a case where SCC is in an active state.

In S20 step, the ADAS controller (11) determines whether SCC is active or not.

The SCC can be activated by a driver's choice, for example, by pressing an SCC button provided in the vehicle (10).

When the SCC is activated, the ADAS controller (11) can determine whether or not a vehicle in front (i.e., a preceding vehicle) exists within a set distance (in a step S30) based on sensing information received from the above-described sensor.

In a step S40, the ADAS controller (11) can determine a follow-up state for a target vehicle speed. For example, the ADAS controller (11) may determine whether or not a target vehicle speed follow-up control is being favorably implemented. When the vehicle speed matches the target speed and is maintained for a predetermined period of time, it can be determined that the target vehicle speed follow-up control is being successfully performed. The follow-up state indicates a degree of correspondence between the vehicle's current speed and a target speed.

Through steps S30 and S40, during SCC traveling, in a case where there is no vehicle in front (i.e., no preceding vehicle), or it is determined that the vehicle speed has been consistently maintained at a target vehicle speed for a predetermined period of time, the ADAS controller (11), in step S50, checks the RPM variation (i.e., fluctuations in the RPM) of the engine (16) according to a preset standard in step S50.

In an embodiment, the preset standard may be a fluctuation of 100 RPM occurring five times, but the present disclosure is not limited thereto.

In other words, when the RPM of the engine (16) fluctuates by 100 RPM consecutively five times, the ADAS controller (11) determines that an RPM variation has occurred in step S50.

When it is determined that the RPM variation has occurred in step S50, the ADAS controller (11) performs a step S60.

In step S60, the ADAS controller (11) performs virtual gear-shift control, and this is described below.

First, the ADAS controller (11) divides a transmission ratio of the transmission (17) into a plurality of virtual gears.

For example, as illustrated in FIG. 3, the transmission ratio can be divided into virtual gears 1 through 8 (i.e., eight virtual gear stages) according to a pulley ratio of the transmission (17). In the present embodiment, the transmission may implement eight virtual gears. This is aimed to cause the transmission (17) to operate like a 8-gear-stage automatic transmission that is commonly used in general, but the transmission ratio is not necessarily limited thereto.

In addition, in FIG. 3, for example, the virtual gear 1 can correspond to a minimum pulley ratio of the transmission (17), and the virtual gear 8 can correspond to a maximum pulley ratio.

The ADAS controller (11) implements virtual gear-shift control with a plurality of virtual gears described above. In other words, the ADAS controller (11) controls the continuously variable transmission (17) as an 8-speed transmission that provides gear shift from virtual gear 1 to virtual gear 8.

As the virtual gear-shift control starts, the ADAS controller (11) can determine a drive point based on the current vehicle speed and the RPM of the engine (16), and can determine a gear which is the closest to the drive point among the plurality of virtual gears as a current gear.

For example, in FIG. 3, when a current drive point P1 is determined based on a current vehicle speed V1 and a current RPM1, a virtual gear 6 is determined as a virtual gear that is the closest to the current drive point P1.

When a shift gear is determined as above, the ADAS controller (11) controls the transmission (17) such that the current transmission ratio is fixed to the corresponding virtual gear (here, virtual gear 6), and then performs the SCC.

FIG. 4 illustrates a shift pattern map for fixed virtual gears of FIG. 3, and the ADAS controller (11) controls the transmission (17) by using such a shift pattern map. In an embodiment, the shift pattern map of FIG. 4 stores APS values and vehicle speed data corresponding to each shift pattern line in a table format, and uses the stored data in shift control.

The shift pattern of FIG. 4 can be obtained by tuning a shift pattern map of a conventional automatic transmission, and since this method is generally well-known, a detailed description except for those required for description of the present embodiment is omitted.

In the shift pattern map of FIG. 4, solid lines illustrate up-shifting, and dotted lines illustrate down-shifting.

In FIG. 4, GC1 represents a shift pattern line for shifting from the virtual gear 1 to the virtual gear 2, GC2 represents a shift pattern line for shifting from the virtual gear 2 to the virtual gear 3, GC3 represents a shift pattern line for shifting from the virtual gear 3 to the virtual gear 4, GC4 represents a shift pattern line for shifting from the virtual gear 4 to the virtual gear 5, GC6 represents a shift pattern line for shifting from the virtual gear 6 to the virtual gear 7, and GC7 represents a shift pattern line for shifting from the virtual gear 7 to the virtual gear 8.

In addition, in FIG. 4, GC1′ represents a shift pattern line for shifting from the virtual gear 2 to the virtual gear 1, GC2′ represents a shift pattern line for shifting from the virtual gear 3 to the virtual gear 2, GC3′ represents a shift pattern line for shifting from the virtual gear 4 to the virtual gear 3, GC4′ represents a shift pattern line for shifting from the virtual gear 5 to the virtual gear 4, GC6′ represents a shift pattern line for shifting from the virtual gear 7 to the virtual gear 6, and GC7′ represents a shift pattern line for shifting from the virtual gear 8 to the virtual gear 7.

When a shift pattern with the same standard is applied to the up-shifting and the down-shifting, frequent shift is made and thus uncomfortable impact frequently occurs. Therefore, a shift gear is determined by varying the shift standard as in FIG. 4 to prevent such a phenomenon.

Hereinafter, a shift process according to the present embodiment is described with reference to FIG. 4 by assuming an acceleration situation at the above-described drive point P1.

While the current virtual shift gear is fixed at the virtual gear 6, when a demand torque is determined based on the execution of the SCC—such as, for example, in response to acceleration required to increase the current vehicle speed to a target vehicle speed—the ADAS controller (11) determines a virtual APS value from the demand torque. The virtual APS value can be obtained from the demand torque by inversely apply the conventional method of calculating a demand torque from an APS value according to accelerator pedal input.

When assuming that the virtual APS is determined to APS1, a drive point P2 in the shift pattern map of FIG. 4 moves rightward (arrow direction of FIG. 4) as the vehicle (10) is accelerated by an output of the engine (16) according to the demand torque.

At this time, as the drive point P2 passes line GC6, the transmission ratio of the transmission (17) is controlled to be changed from the virtual gear 6 to the virtual gear 7.

When the RPM variation is determined to be less than a set standard (in a step S50), the ADAS controller (11) performs general SCC control (in a step S70). In other words, continuous transmission ratio control is performed on the continuously variable transmission (17).

Step S80 represents a case where there is a driver's drive intervention, and then the process proceeds to a step S10.

FIG. 5 represents a known shift pattern for the continuously variable transmission (17), and such a shift pattern can be used in the step S70.

As control of the continuously variable transmission (17) due to the shift pattern of FIG. 5 is generally known, detailed description beyond this is omitted.

FIG. 6A and FIG. 6B conceptually illustrate an engine RPM situation in a case where the conventional control is applied and an engine RPM situation in a case where control of the present embodiment is applied. As illustrated in FIG. 6A, engine RPM variation cannot be resolved according to the conventional control, but according to the control of the present embodiment, as illustrated in FIG. 6B, engine RPM variation is decreased.
10: Vehicle
11: ADAS controller
12: Brake controller
13: Engine controller
14: Transmission controller
15: Brake device
16: Engine
17: Transmission

What is claimed is:

1. A vehicle comprising:
a driving unit;
a continuously variable transmission configured to change a rotational output speed of the driving unit; and
a controller configured to:
control the driving unit based on a set automatic drive control, and
control the continuously variable transmission according to a virtual gear-shift control based on a state of the driving unit during the set automatic drive control.

2. The vehicle according to claim 1,
wherein the state of the driving unit includes a revolution per minute (RPM) state of the driving unit.

3. The vehicle according to claim 2,
wherein the RPM state includes a state in which an RPM variation greater than or equal to a preset value occurs at least a preset number of times.

4. The vehicle according to claim 1,
wherein the controller is further configured to determine that a preceding vehicle is present within a preset distance, and to start the virtual gear-shift control.

5. The vehicle according to claim 1,
wherein the controller is further configured to start the virtual gear-shift control based on a follow-up state indicative of a degree of correspondence between a current vehicle speed and a target vehicle speed of the vehicle.

6. The vehicle according to claim 1,
wherein the controller is configured to:
divide a transmission ratio of the continuously variable transmission into a plurality of virtual gears, and
control the continuously variable transmission based on the plurality of virtual gears.

7. The vehicle according to claim 6,
when controlling the continuously variable transmission based on the plurality of virtual gears, the controller is configured to select a virtual gear among the plurality of virtual gears based on a current vehicle speed and a revolution per minute (RPM) of the driving unit.

8. The vehicle according to claim 6,
wherein when controlling the continuously variable transmission based on the plurality of virtual gears, the controller is configured to determine a virtual accelerator pedal sensor (APS) value based on a target torque, and perform a gear shift from a first virtual gear to a second virtual gear, among the plurality of virtual gears, based on the virtual APS value.

9. The vehicle according to claim 8,
wherein the gear shift among the plurality of virtual gears includes up-shifting or down-shifting according to the virtual APS value, a current vehicle speed, and a preset shift pattern.

10. The vehicle according to claim 1,
wherein the automatic drive control includes a cruise control.

11. A method of controlling a vehicle including a driving unit, a continuously variable transmission configured to change a rotational output speed of the driving unit, and a controller configured to control the driving unit and the continuously variable transmission, the method comprising:
controlling, by the controller, the driving unit based on a set automatic drive control; and
controlling the continuously variable transmission according to a virtual gear-shift control based on a state of the driving unit during the automatic drive control.

12. The method according to claim 11,
wherein the state of the driving unit includes a revolution per minute (RPM) state of the driving unit.

13. The method according to claim 12,
wherein the RPM state includes a state in which an RPM variation greater than or equal to a preset value occurs at least a preset number of times.

14. The method according to claim 11,
wherein controlling the continuously variable transmission according to the virtual gear-shift control includes:
determining that a vehicle traveling in front of the vehicle exists within a preset distance, and
starting the virtual gear-shift control.

15. The method according to claim 11,
wherein controlling the continuously variable transmission according to the virtual gear-shift control includes starting the virtual gear-shift control based on a follow-up state indicative of a degree of correspondence between a current vehicle speed and a target vehicle speed.

16. The method according to claim 11,
wherein the virtual gear-shift control includes:
dividing a transmission ratio of the continuously variable transmission into a plurality of virtual gears, and
controlling the continuously variable transmission based on the plurality of virtual gears.

17. The method according to claim 16,
wherein controlling based on the plurality of virtual gears includes controlling the continuously variable transmission according to a virtual gear selected among the plurality of virtual gears based on a current vehicle speed and a revolution per minute (RPM) of the driving unit.

18. The method according to claim 17,
wherein controlling based on the plurality of virtual gears further includes determining a virtual accelerator pedal sensor (APS) value based on a target torque, and shifting from a first virtual gear to a second virtual gear, among the plurality of virtual gears, based on the virtual APS value.

19. The method according to claim 18,
wherein shifting from the first virtual gear to the second virtual gear, among the plurality of virtual gears, includes up-shifting or down-shifting based on the virtual APS value, the current vehicle speed, and a preset shift pattern.

20. The method according to claim 11,
wherein the automatic drive control includes a cruise control.
